(19) United States
(12) Patent Application Publication
(10) Pub. No.: US 2022/0303152 A1
(43) Pub. Date: Sep. 22, 2022

(54) RECORDATION OF VIDEO CONFERENCE BASED ON BANDWIDTH ISSUE(S)

(71) Applicant: Lenovo (Singapore) Pte. Ltd., Tokyo (JP)

(72) Inventors: Robert James Norton, JR., Raleigh, NC (US); Scott Wentao Li, Cary, NC (US); Robert J. Kapinos, Durham, NC (US); Russell Speight VanBlon, Raleigh, NC (US)

(21) Appl. No.: 17/205,694

(22) Filed: Mar. 18, 2021

(51) Int. Cl. H04L 12/18; H04N 7/14

(52) U.S. Cl. CPC H04L 12/1831; H04N 7/147

(57) ABSTRACT

In one aspect, a first device includes at least one processor and storage accessible to the at least one processor. The storage includes instructions executable by the at least one processor to facilitate a video conference between second and third devices and, during a first segment of the video conference, receive a recording of a second segment of the video conference that transpired prior to the first segment. The instructions are also executable to save the recording at the first device and stream, during a third segment of the video conference after the first and second segments, the recording to one or more of the second and third devices.

### FIELD

The disclosure below relates to technically inventive, non-routine solutions that are necessarily rooted in computer technology and that produce concrete technical improvements. In particular, the disclosure below relates to techniques for recording part of a video conference based on bandwidth issues.

### BACKGROUND

As recognized herein, modern electronic communication infrastructures sometimes experience packet loss and other bandwidth issues due to the number of users trying to use the infrastructure at the same time. As also recognize herein, the lack of adequate bandwidth during a video conference can lead its participants to miss some of what each other is saying as well as to overall data loss. There are currently no adequate solutions to the foregoing computer-related, technological problem specifically arising in computer networks.

### SUMMARY

Accordingly, in one aspect a first device includes at least one processor and storage accessible to the at least one processor. The storage includes instructions executable by the at least one processor to facilitate a video conference between second and third devices and, during a first segment of the video conference, receive a recording of at least part of a second segment of the video conference that transpired prior to the first segment. The instructions are also executable to save the recording at the first device and stream, at a later time occurring after the first and second segments, the recording to one or more of the second and third devices.

Thus, in some examples the instructions may be executable to stream the recording during a third segment of the video conference occurring after the first and second segments. In non-limiting examples, the instructions may also be executable to transmit, during a fourth segment of the video conference occurring prior to the first and second segments, a request for the recording to one of the second and third devices and to then receive the recording responsive the request and during the first segment. If desired, the instructions may also be executable to, during a fifth segment, transmit an indication to the other device from which the recording was received. The indication may indicate that a bandwidth issue has improved, and that the other device need not continue to record the video conference locally at the other device. The other device may be established by one of the second and third devices. Also, in some examples, the request for the recording may include a command to generate the recording locally at the respective device to which the request is transmitted.

Still further, in some example implementations the instructions may be executable to record, at the first device, the first and third segments. In these examples, the instructions may then be executable to, based on the video conference ending, generate and store a composite recording including the first and third segments as recorded at the first device and including the second segment as received by the first device.

Also note that in various examples, the recording of the part of the second segment may include at least audio of a particular video conference participant.

Still further, if desired the recording may be streamed responsive to receipt, at the first device, of a request for the recording from one of the second and third devices.

Additionally, in some example embodiments the instructions may be executable to control a display to present a graphical user interface (GUI). The GUI may indicate that the recording is available and that the recording is associated with a particular participant of the video conference. The GUI may also include a selector that is selectable to request the stream of the recording. Still further, in some examples the display may be located on one of the second and third devices, and the first device may control the display through a software application being used to facilitate the video conference. Thus, the first device may, for example, include a server.

In another aspect, a method includes facilitating, at a first device, an electronic conference between second and third devices. The method also includes, at the first device and during a first segment of the electronic conference, receiving a recording of at least part of a second segment of the electronic conference that transpired prior to the first segment. The method then includes saving the recording using the first device and transmitting, during a third segment of the electronic conference after the first and second segments, the recording to one or more of the second and third devices.

Additionally, if desired the method may include transmitting, during a fourth segment of the electronic conference occurring prior to the first and second segments, a request for the recording to one of the second and third devices. The method may then include receiving the recording based on the request. In some examples, the request for the recording may include a command to generate the recording locally at the respective device to which the request is transmitted.

Additionally, in some examples the method may include recording, using the first device, the first and third segments. In these examples the method may then include generating and making available a composite recording of the first, second, and third segments.

Still further, in some examples the recording may be transmitted responsive to receipt, at the first device, of a request for the recording from one of the second and third devices.

Also, in some examples, the method may include controlling a display to present a graphical user interface (GUI). The GUI may indicate that the recording is associated with a particular participant of the electronic conference, and the GUI may even include a selector that is selectable to request the recording. If desired, the display may be located on one of the second and third devices, and the first device may control the display through a software application being used to facilitate the electronic conference.

In still another aspect, at least one computer readable storage medium (CRSM) that is not a transitory signal includes instructions executable by at least one processor to facilitate, at a first device, a video conference with a second device. The instructions are also executable to receive a transmission from a third device to begin recording the video conference locally at the first device, where the third device is different from the first and second devices. Based on the transmission, the instructions are executable to begin recording the video conference locally at the first device. The video conference is recorded locally at the first device from a point other than the beginning of the video conference. The instructions are also executable to save the local recording at the first device and transmit the local recording to the third device.

In some examples, the local recording may be a first recording and the instructions may be executable to present a graphical user interface (GUI) on a display accessible to the first device. The GUI may indicate that a second recording associated with a user of the second device is available, where the second recording may be different from the first recording. In these examples, the GUI may include a selector that is selectable to request the second recording be transmitted to the first device.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIG. 3 illustrates example logic in example flow chart format that may be executed by a video conference server consistent with present principles;

FIG. 4 illustrates example logic in example flow chart format that may be executed by a video conference participant's own personal device/client device consistent with present principles;

FIG. 5 shows an example graphical user interface (GUI) that may be presented on the display of a respective client device during a video conference consistent with present principles;

FIGS. 6 and 7 show example pop-up GUIs that may also be presented on the display of a respective client device during a video conference to inform the participant regarding a bandwidth problem consistent with present principles;

FIG. 8 shows an example GUI that may be presented on the display of a respective client device after a video conference ends consistent with present principles; and

FIG. 9 shows an example settings GUI that may be presented on a display to configure one or more settings of a device to operate consistent with present principles.

### DETAILED DESCRIPTION

Among other things, the disclosure below involves empowering a video conferencing server and/or another device driving a virtual meeting/conference to detect a degraded connection from the individual clients connected as part of the meeting. Upon identifying the clients that are experiencing issues, the server may trigger the clients to start recording their own respective parts of the meeting on the local client side until the server sends another notification that the degraded connection has cleared up. From that point, the local client may then place a timestamp on each of its recordings and associate or tag the recording with a respective participant to which each recording pertains. The timestamp and tag of the participant may be placed in the recording's metadata, for example. The local client can then upload each recording and its metadata to the server so it can be downloaded or streamed to another client and then listened to by other members of the meeting either in real time while the meeting continues and/or after the call.

Additionally, a GUI may be presented on each client device's display that shows the recordings that are available for each individual participant of the meeting, as well that allows all meeting participants to listen to each recording when they are ready. Furthermore, in some examples the server may also take all “clean” uploads/recordings of various segments and insert, at the right times, those into the master recording of the meeting as recorded at the server to create a “clean” replay of the meeting's audio and video even if part of the original master recording performed at the server was corrupted due to packet loss from one of the client devices providing a respective audio video (AV) feed.

These aspects may be useful in any number of situations, including distance learning, business meetings, civic group meetings, etc.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino Calif., Google Inc. of Mountain View, Calif., or Microsoft Corp. of Redmond, Wash. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any general purpose single- or multi-chip processor that can execute logic by means of various lines such as address lines, data lines, and control lines and registers and shift registers. Moreover, any logical blocks, modules, and circuits described herein can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, CD ROM or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library.

Logic when implemented in software, can be written in an appropriate language such as but not limited to hypertext markup language (HTML)-5, Java/JavaScript, C# or C++, and can be stored on or transmitted from a computer-readable storage medium such as a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

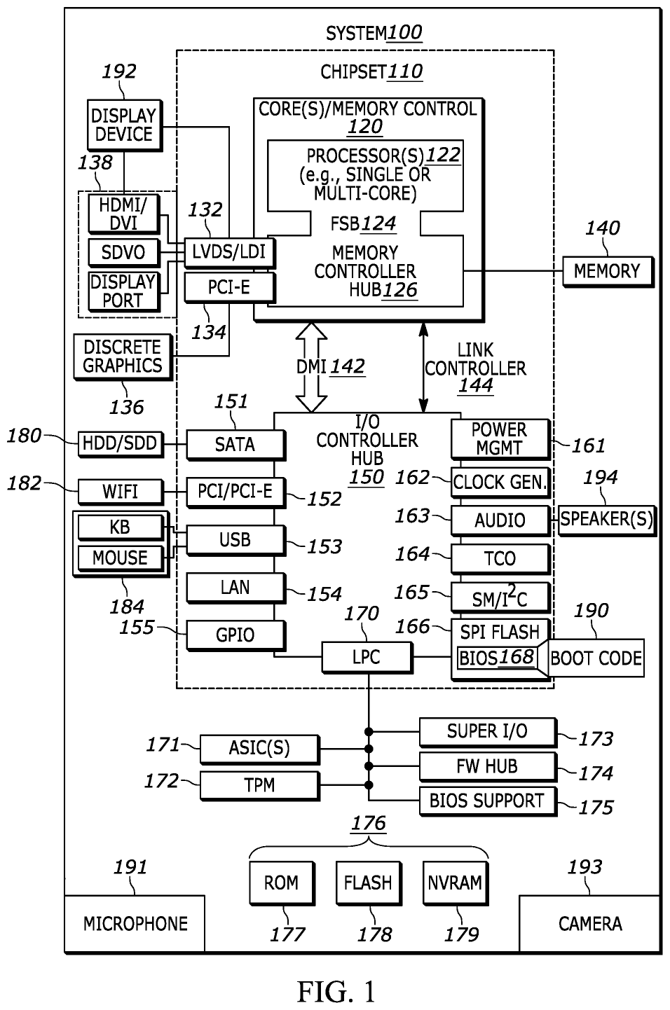

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Still further, the system 100 may include an audio receiver/microphone 191 that provides input from the microphone 191 to the processor 122 based on audio that is detected, such as via a user providing audible input to the microphone as part of a video conference consistent with present principles. The system 100 may also include a camera 193 that gathers one or more images and provides the images and related input to the processor 122. The camera 193 may be a thermal imaging camera, an infrared (IR) camera, a digital camera such as a webcam, a three-dimensional (3D) camera, and/or a camera otherwise integrated into the system 100 and controllable by the processor 122 to gather still images and/or video such as of a person while video conferencing consistent with present principles.

Additionally, though not shown for simplicity, in some embodiments the system 100 may include a gyroscope that senses and/or measures the orientation of the system 100 and provides related input to the processor 122, as well as an accelerometer that senses acceleration and/or movement of the system 100 and provides related input to the processor 122. The system 100 may also include a global positioning system (GPS) transceiver that is configured to communicate with at least one satellite to receive/identify geographic position information and provide the geographic position information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

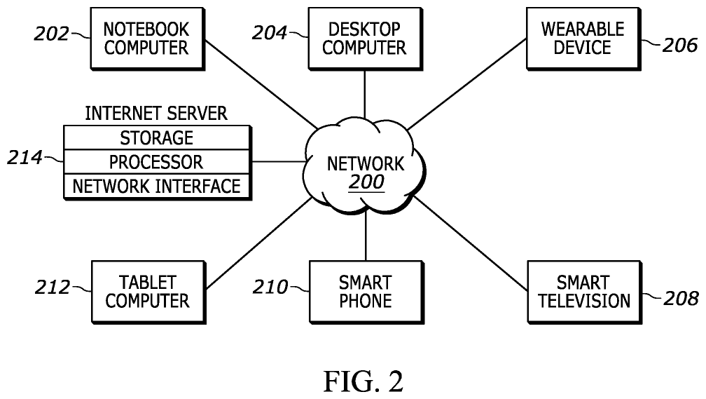

Turning now to FIG. 2, example devices are shown communicating over a network 200 such as the Internet consistent with present principles, such as to transmit audio/video (AV) data of different video conference participants to other respective devices as part of a video conference. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 may be configured to communicate with each other over the network 200 to undertake present principles related to video conferencing.

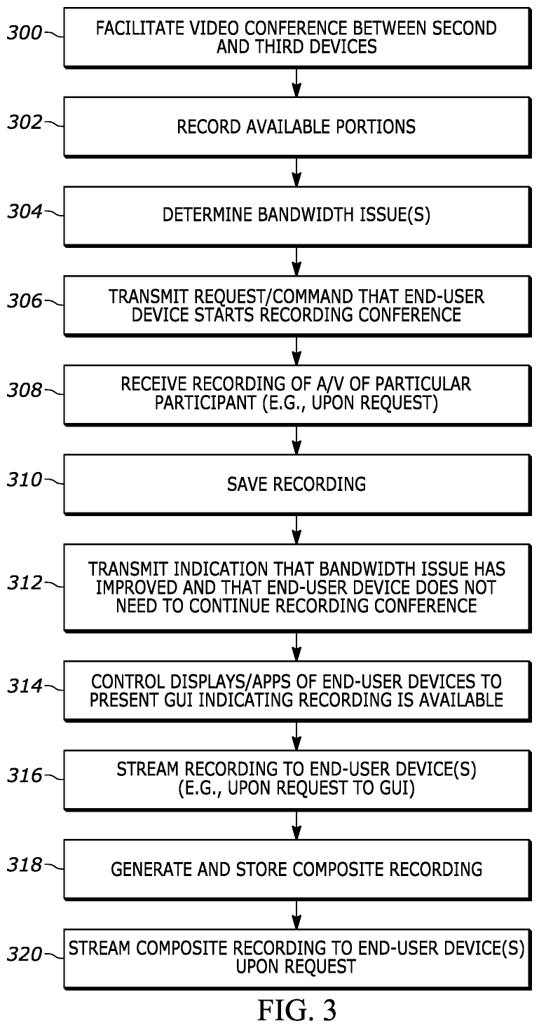

Referring now to FIG. 3, suppose that a video conference is transpiring between various remotely-located participants using their own respective client/personal devices to participate. The personal devices may be smartphones, laptop computers, tablet computers, etc. Also suppose that the audio and/or video feed from one of the participant's devices has degraded or that parts thereof are not being received due to bandwidth or other network connection issues. The logic of FIG. 3 may be executed by a server or other device facilitating the video conference (such as another one of the participant devices) to address this computer-specific issue related to video conferencing.

Thus, FIG. 3 shows example logic that may be executed by a first device such as the system 100, a server coordinating the conference, etc. in accordance with present principles. Note that while the logic of FIG. 3 is shown in flow chart format, state logic or other suitable logic may also be used.

Beginning at block 300, the first device may facilitate the video conference between second and third devices by, for example, relaying audio/video (AV) feeds from one of the second and third devices to the other, where each AV feed includes audio and video of a respective participant. Thereafter the logic may proceed to block 302 where the first device may timestamp and record available portions of the AV feeds in real time as received at the first device (from the second and third devices) based on sufficient bandwidth.

The logic may then proceed to block 304 where the first device may determine during any segment of the video conference whether any bandwidth or other network connectivity issues might exist based on one or more portions/packets of the various AV feeds not being received by the first device. For example, if an AV feed is determined to be frozen, if an audio component and/or video component of the AV feed is not received in real time as expected, or if certain packets have been dropped in transit, a bandwidth issue may be determined at block 304. Based on such a determination, the logic may proceed to block 306.

At block 306 the first device may transmit a request (e.g., command) to the respective client/end-user device from which part of the respective AV feed was not received to start recording local audio and visual input to that respective device. The respective device may be either of the second or third device (or another end-user device if more than two participants are participating in the video conference). Additionally, note that even if there is a connection problem between the first device and other device resulting in the AV feed not being received by the first device, the request/command from the first device to start the local recording may still go through using the same network(s) since such a command may require less bandwidth to be successfully transmitted owing to less total data being included as part of the transmission relative to the AV feed itself. However, in addition to or in lieu of that, if insufficient bandwidth exists to transmit the command, the first device may wait until bandwidth is sufficient and then transmit the command at that time (e.g., even if bandwidth is still not sufficient to receive the AV feed itself).

However, also note that in some examples the first device may also communicate the command through an out-of-band connection, e.g., a different data connection than being used for the video conference itself. For example, if a Wi-Fi network and/or LAN were used as part of an Internet connection being used for the conference, the command may be sent over a separate wireless cellular network through which the two devices are also configured to communicate. In some examples, the command may even be sent via a short-message-service (SMS) text message using the cellular network while the video conference is still maintained over a separate Internet connection.

From block 306 the logic may then proceed to block 308. At block 308 the first device may receive back a recording of the AV of the particular participant as recorded at that participant's own personal device. The other device may transmit the local recording to the first device on its own volition, such as responsive to the bandwidth issue being identified as resolved or improved while the video conference is still ongoing, or even responsive to identification of the video conference as ending. However, the other device may also transmit the local recording responsive to receipt of a request for the recording from the first device itself. And again, note that the local recording may include at least an audio feed of the respective participant speaking as part of the conference during a given segment of the video conference, if not also including a video feed of the respective participant speaking as part of the video conference during that segment that can be played back via a display.

From block 308, the logic may proceed to block 310 where the first device may timestamp the recording with the time within the video conference to which it pertains and then save the received recording in its own persistent storage or even persistent cloud storage maintained at another device. For example, the received recording may be stored in a same folder or file path at which other portions of the video conference were already being stored once recorded at block 302. The logic may then proceed to block 312.

At block 312 the first device may, at a later time/segment responsive to determining that the bandwidth issue has been resolved and/or that the first device is successfully receiving data packets in the correct order from the respective end-user device, transmit an indication to that device that the bandwidth issue has improved, and that the other device does not need to continue recording its portion of the AV feed locally. From block 312 the logic may then proceed to block 314.

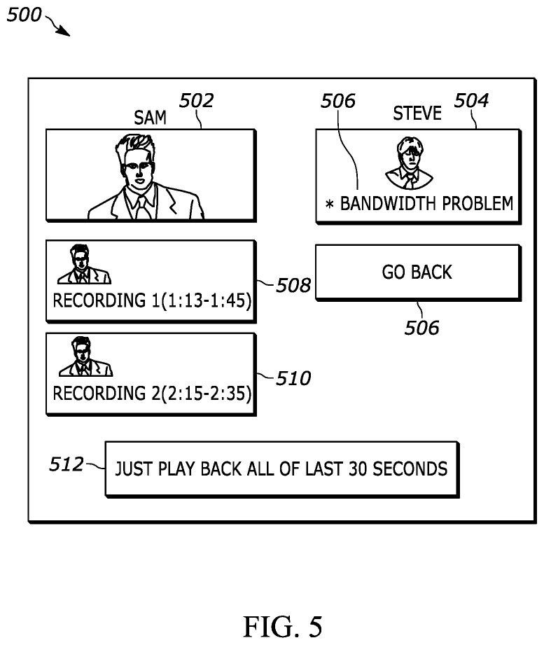

At block 314 the first device may control the respective displays of the second and/or third devices to present or update a graphical user interface (GUI) being used for the video conference at the second and/or third device. The GUI may be presented or updated to indicate that the recording received at the first device is available for playback at the second or third device. For instance, if a bandwidth issue was experienced between the first and second devices, the user of the third device may have missed something that the user of the second device said and therefore elect to playback a recording of the user of the second device as received from the first device. Note that the first device may control the display of the other device to present or update the GUI on the other device using a video conferencing software application used to facilitate the video conference, a copy of which may be executing locally at the other device and may be in communication with the first device. An example of such a GUI will be discussed below in reference to FIG. 5.

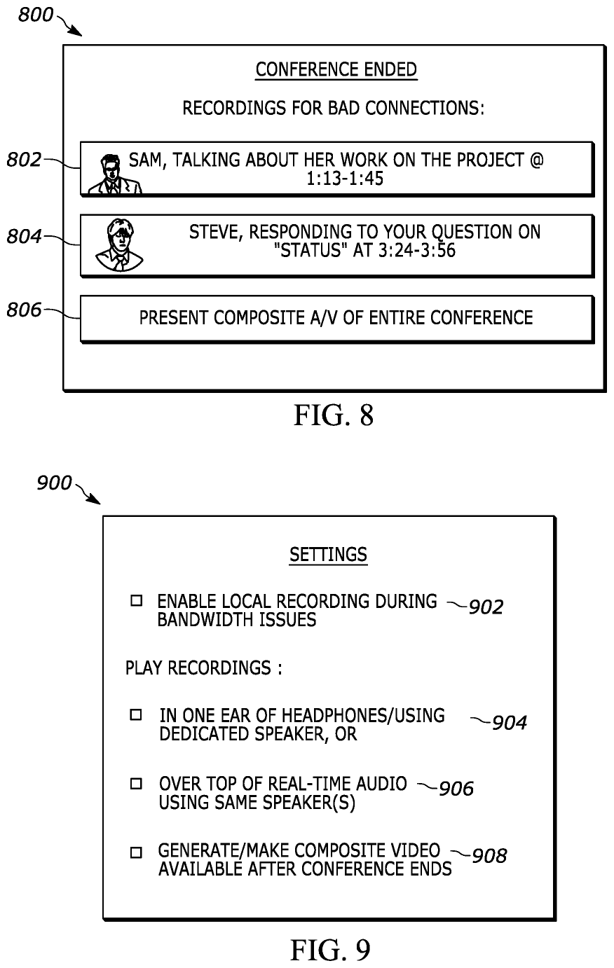

But still in reference to FIG. 3, from block 314 the logic may next proceed to block 316. At block 316 the first device may, during a later segment of the conference, stream the saved recording to one or more end-user devices that might have requested it through a GUI presented on their displays, such as the GUI of either of FIGS. 5 and 8. Thus, the first device may stream the recording to the requesting device while the video conference is ongoing or even after it ends, depending on when the request is received.

From block 316 the logic may proceed to block 318. At block 318 the first device may generate and store a composite recording, e.g., using video editing software. The composite recording may be generated responsive to and/or based on the video conference ending, for example. The composite recording may include both the recording received at block 308 from one of the second and third devices as well as any additional recording(s) of the video conference that might have been recorded at the server itself at block 302. Thus, in some example embodiment the composite recording may establish a recording of consecutive segments of the video conference from beginning to end regardless of whether the segments were recorded at the first device or the participants' own devices (the second and third devices in this example). Accordingly, the composite recording may establish a continuous, uninterrupted recording of the video conference from start to finish so that a participant can go back and watch it later without any having to view the AV interruptions or corruptions that might have been experienced in real time due to whatever bandwidth issues might have occurred. This may be done by taking the recording(s) generated by the second and/or third devices and using them to replace any corresponding portions of the video conference as recorded at the first device for the same time period but that have gaps or interruptions in the audio and/or video due to the bandwidth problems. In so doing, the resulting composite video may not include those gaps or interruptions but show the video conference from start to finish as if it was recorded without any packet/data loss.

Finishing the description of FIG. 3, from block 318 the logic may then proceed to block 320 where the first device may stream or otherwise make available the composite recording (as stored at the first device or in other accessible storage) to one or more end-user devices upon their request, such as making the composite recording available to the second or third devices.

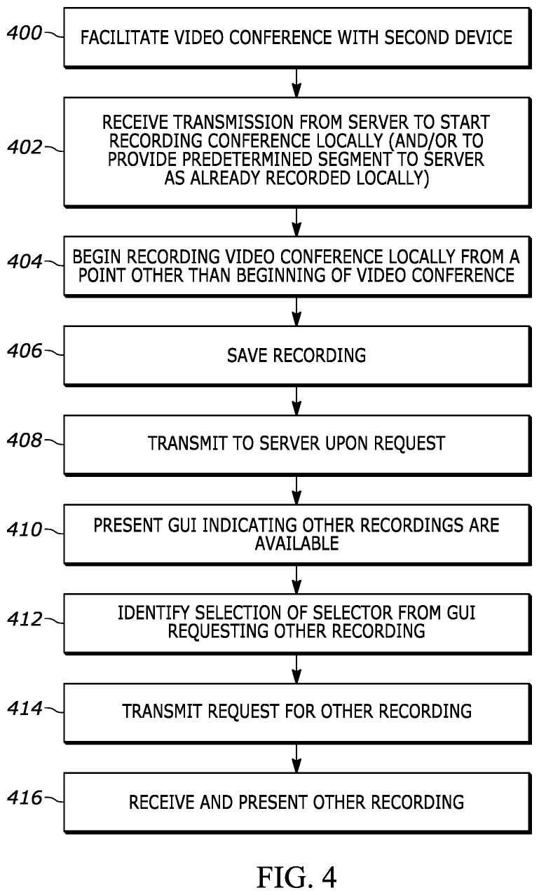

Now describing FIG. 4, it shows example logic that might be executed by a respective end-user device while its participant participates in a video conference with another person that is remotely located consistent with present principles. Note that while the logic of FIG. 4 is shown in flow chart format, state logic or other suitable logic may also be used.

Beginning at block 400, the end-user device may facilitate a video conference with another device such as by transmitting local video from its camera and local audio from its microphone to the other device, possibly as routed through a server as described above.

From block 400 the end-user device may then proceed to block 402 where the end-user device may receive a transmission from a server or other device to begin recording the video conference inputs (to the microphone and camera) locally at the end-user device. Additionally, or alternatively, if the end-user device were already by default recording some or all of the video conference inputs locally, at block 402 a transmission might be received from the server to provide a predetermined segment indicated by the server and already recorded by the end-user device.

Or also in some examples, at block 402 the end-user device might itself determine that a bandwidth issue has arisen, and that the server or other participant's device might not be successfully receiving all of its AV transmission. The end-user device might determine as much if it too is experiencing packet loss related to packets that were supposed to be received from the server or other participant's device, for example, or if the end-user device received a notification that the packets of AV it was transmitting were not being successfully received by the server or other participant's device.

From block 402 the logic may then proceed to block 404. At block 404 the end-user device may actually begin recording the video conference locally, e.g., from a point other than the beginning of the video conference. For example, the end-user device may begin recording the video conference responsive to receiving the transmission at block 402 described above for a segment of the video conference indicated in the transmission. Additionally, or alternatively, the end-user device may begin recording the video conference at block 404 based on a determination by the end-user device itself that, at some point after the video conference began, packet loss or other bandwidth issues were identified as also described above. Thereafter, the logic may proceed to block 406 where the end-user device may store the recorded segment of the video conference locally in its own persistent storage, such as a hard disk drive or solid-state drive within the end-user device. In some examples, the recorded segment may additionally or alternatively be stored in RAM for quicker transmission to the server upon request.

Thereafter, the logic may proceed to block 408 where the end-user device may transmit the locally-recorded segment(s) to the server or other device, e.g., upon request from the server or other device. Thereafter, the logic may proceed to block 410.

At block 410 the end-user device may present a GUI on its own display indicating that other recordings might be available, such as for a same segment of the video conference but for the AV feed from the other participant's device (e.g., in a situation where bandwidth was so limited that neither end-user device received the other's AV feed during a certain segment of the video conference). The GUI may indicate other available recordings as well, including those that might have been recorded by the other device or server itself for other segments of the conference. Thus, the GUI presented at block 410 may be established by either of the GUIs of FIGS. 5 and 8.

The logic may then proceed to block 412 where the end-user device may identify selection of a selector from the GUI presented at block 410. The selection may thus establish a request for another recording to be provided to the end-user device. Accordingly, at block 414 the request may be transmitted based on selection of the selector and then at block 416 the end-user device may receive and present the requested recording.

Now in reference to FIG. 5, it shows an example GUI 500 that may be presented on the display of an end-user's device while it facilitates a video conference. As shown, real time video feeds 502, 504 of two respective remote participants named Sam and Steve are shown. It is to be understood that real time audio of those participants may also be presented using a speaker located on the end-user's device.

As also shown in FIG. 5, overlaid on the video feed 504 is a star icon and text indication 506 that the end-user device and/or server has detected a bandwidth problem resulting in some or all of the audio or video component of Steve's AV feed not being delivered to the end-user device presenting the GUI 500. Accordingly, a selector 506 may also be presented and may be selectable to command the end-user device to play back a most-recent predetermined segment/amount of only Steve's AV feed for the video conference (e.g., a most-recent thirty seconds). Thus, responsive to selection of the selector 506, the end-user device may request a recording of the most-recent thirty-second segment of Steve's AV feed either directly from Steve's own device or from the server once the server has received the recording from Steve's device.

The recording may then be played back at the end-user device by muting the real-time audio feed of the video conference while the recording is played back. Or if headphones or plural speakers are being used at the end-user device to provide the video conference's audio, one speaker or side of the headphones may stop presenting the real-time audio feed and instead present the recording while the other speaker(s) continue presenting the real-time audio feed. Or the recording may simply be played over top of the real-time audio feed so that both are presented concurrently using the same speaker(s).

As also shown in FIG. 5, the GUI 500 may include selectors 508 and 510. As shown, each of these selectors may include an icon or avatar showing Sam's face to indicate that associated recordings are of audio from Sam. The recordings indicated by the selectors 508, 510 might not be recordings from a most-recent segment of the video conference but recordings from a segment farther back instead so that the user of the device presenting the GUI 500 can go back and listen to segments that were not successfully transmitted in real-time due to bandwidth issues at any point during the video conference. As also shown in FIG. 5, in some examples the selectors 508, 510 may even include different titles for the different respective recordings as well as timestamps indicating the segments of the video conference to which they pertain. For example, selector 508 indicates that the recording is for a segment of the video conference from minute one, thirteen seconds to minute one, forty-five seconds. Segment lengths need not all be the same and may each be defined by the length of a given bandwidth issue resulting in a real-time feed not being received in real-time by other participant devices and/or the server, for example.

Still further, in some examples the GUI 500 may include a selector 512. The selector 512 may be selected to command the end-user device to play back a most-recent predetermined amount (e.g., thirty seconds) of the entire video conference so that the video conference is played back with not just Steve's AV feed but the overall AV feed that might also include Sam's AV feed and the AV feed of any other conference participants as well.

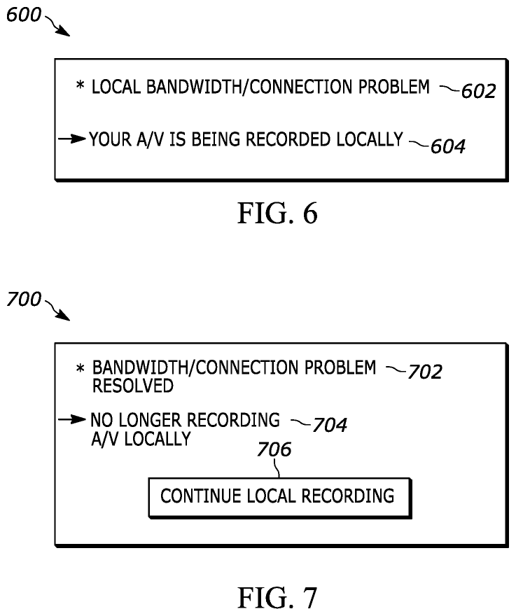

Now describing FIG. 6, it shows an example GUI 600 that may be presented on an end-user device responsive to detecting a bandwidth problem with either outgoing or inbound transmission of a video conference's AV feed. The GUI 600 may be overlaid on a portion of the GUI 500 for a threshold amount of time and then disappear, for example. As shown, the GUI 600 may include a text indication 602 that a bandwidth problem has been identified locally, either by the device itself or based on receiving an indication from the video conference's server or another participant's device that a bandwidth problem is being experienced and hence the local AV feed is not being received by others. The indication 602 may be accompanied by another indication 604 that, as a consequence, the participant's own AV feed is being recorded locally.

Then once sufficient bandwidth exists for the participant's AV feed to again be transmitted and received by the server and other devices successfully in real time, the GUI 700 of FIG. 7 may be presented. As with the GUI 600, the GUI 700 may also be overlaid on part of the GUI 500 and disappear after a threshold amount of time. As shown, the GUI 700 may include a text indication 702 that the bandwidth problem no longer exists. Thus, the indication 702 may be accompanied by an indication 704 that, as a consequence, the participant's own AV feed is no longer being recorded locally. However, if for some reason the participant wishes to still record subsequent segments of the video conference locally, the participant may select the selector 706 to command his/her device to do so.

Now describing FIG. 8, it shows an example GUI 800 that may be presented on the display of an end-user device once a video conference ends. For example, the GUI 800 may be presented at any time after the conference ends upon request from a user, and/or the GUI 800 may be presented responsive to the conference itself ending so that it is presented immediately afterwards.

Regardless, as shown in FIG. 8 the GUI 800 may include respective selectors 802, 804 for each respective segment of the video conference during which a bandwidth problem occurred that resulted in packet loss for the AV feed of one of the conference participants (and hence not all AV packets for the segment being delivered to one or more other participants and/or not being delivered to the server itself that is managing the conference). Thus, note that in example embodiments segment length corresponding to each selector 802, 804 may vary depending on the length of the bandwidth issue in that a given recorded segment may correlate to the bandwidth interruption length itself. Also note that each selector 802, 804 may be selected to initiate playback at the local device on which the GUI 800 is presented of just the AV feed (as recorded) for the respective participant device for which packet loss occurred and that not for all AV feeds that were streamed during the respective segment. Also note that although only two selectors 802, 804 are shown, a selector may be presented for each respective recording of the video conference for which packet loss or other bandwidth problems occurred.

As shown in FIG. 8, each respective selector 802, 804 may include an icon or avatar showing the respective face of the respective participant to indicate that associated recording is of AV for the respective participant. As also shown in FIG. 8, in some examples the selectors 802, 804 may even include timestamps indicating the segments of the video conference to which they pertain. with each timestamp indicating a time range measured from the beginning of the conference. For example, selector 802 indicates that the recording is for a segment of the video conference from minute one, thirteen seconds to minute one, forty-five seconds.

Also note that in some examples, the selectors 802, 804 may include a respective sentence or two, or even a partial phrase, indicating the subject and/or content of the audio portion of the associated recording itself. For example, while processing the recordings to make them available to video conference participants, the video conference server or another device may execute natural language processing and/or natural language understanding on the audio component to identify the subject and/or content of the audio component to then present it on the face of the respective selector 802, 804. This may help a given user/participant decide, upon viewing the text on the selectors 802, 804, whether the content of the respective recording is something they missed and/or desire to hear.

Similar subjects and content of the audio portions of the recordings corresponding to the selectors 508, 510 of FIG. 5 may also be presented on those respective selectors, though not shown in FIG. 5 for simplicity. And note further that the titles of the selectors 508, 510 as described above might have been similarly determined using natural language understanding.

In any case, still in reference to FIG. 8, in some examples the GUI 800 may include a selector 806. The selector 806 may be selectable to initiate playback of a composite recording of the video conference as may have been generated at block 318 of FIG. 3 as described above.

Now describing FIG. 9, it shows an example GUI 900 that may be presented on the display of a server or local client device configured to undertake present principles. The GUI 900 may be presented for configuring one or more settings of the device to operate consistent with present principles, and it is to be understood that each option to be discussed below may be selected by directing touch or cursor input to the respectively adjacent check box.

Beginning first with the option 902, it may be selected to set or enable the device to undertake present principles in the future. For example, the option 902 may be selected a single time to set or configure the device to execute the logic of either FIG. 3 or FIG. 4 for multiple different conferences in the future, depending on the device for which settings are being configured (e.g., video conference server or client device).

Additionally, the GUI 900 may include options 904 and 906 to, at a local client device for a respective video conference participant, either present recorded audio of a previous segment using one earpiece speaker of headphones or using another dedicated speaker (option 904), or using the same speaker that might also be concurrently presenting the real-time audio for the other participants of the video conference (option 906).

Still further, if desired the GUI 900 may include an option 908 to specifically set or enable the video conference server (or even one of the client devices) to in the future generate or otherwise make available composite videos of respective video conferences as disclosed herein.

It may now be appreciated that present principles provide for an improved computer-based user interface that increases the functionality and ease of use of the devices disclosed herein. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. A first device, comprising:
at least one processor; and
storage accessible to the at least one processor and comprising instructions executable by the at least one processor to:
facilitate a video conference between second and third devices;
during a first segment of the video conference, receive a recording of at least part of a second segment of the video conference that transpired prior to the first segment;
save the recording at the first device; and
stream, at a later time occurring after the first and second segments, the recording to one or more of the second and third devices.

2. The first device of claim 1, wherein the instructions are executable to:
stream the recording during a third segment of the video conference occurring after the first and second segments.

3. The first device of claim 2, wherein the instructions are executable to:
transmit, during a fourth segment of the video conference occurring prior to the first and second segments, a request for the recording to one of the second and third devices; and
receive the recording responsive the request and during the first segment.

4. The first device of claim 3, wherein the instructions are executable to:
during a fifth segment, transmit an indication to the other device from which the recording was received, the indication indicating that a bandwidth issue has improved, and that the other device need not continue to record the video conference locally at the other device, the other device established by one of the second and third devices.

5. The first device of claim 3, wherein the request for the recording comprises a command to generate the recording locally at the respective device to which the request is transmitted.

6. The first device of claim 2, wherein the instructions are executable to:
record, at the first device, the first and third segments; and
based on the video conference ending, generate and store a composite recording comprising the first and third segments as recorded at the first device and the second segment as received by the first device.

7. The first device of claim 1, wherein the recording of the part of the second segment comprises at least audio of a particular video conference participant.

8. The first device of claim 1, wherein the recording is streamed responsive to receipt, at the first device, of a request for the recording from one of the second and third devices.

9. The first device of claim 1, wherein the instructions are executable to:
control a display to present a graphical user interface (GUI), the GUI indicating that the recording is available and that the recording is associated with a particular participant of the video conference, the GUI comprising a selector that is selectable to request the stream of the recording.

10. The first device of claim 9, wherein the display is located on one of the second and third devices, and wherein the first device controls the display through a software application being used to facilitate the video conference.

11. The first device of claim 1, wherein the first device comprises a server.

12. A method, comprising:
facilitating, at a first device, an electronic conference between second and third devices;
at the first device and during a first segment of the electronic conference, receiving a recording of at least part of a second segment of the electronic conference that transpired prior to the first segment;
saving, using the first device, the recording; and
transmitting, during a third segment of the electronic conference after the first and second segments, the recording to one or more of the second and third devices.

13. The method of claim 12, comprising:
transmitting, during a fourth segment of the electronic conference occurring prior to the first and second segments, a request for the recording to one of the second and third devices; and
receiving the recording based on the request.

14. The method of claim 13, wherein the request for the recording comprises a command to generate the recording locally at the respective device to which the request is transmitted.

15. The method of claim 12, comprising:
recording, using the first device, the first and third segments; and
generating and making available a composite recording of the first, second, and third segments.

16. The method of claim 12, wherein the recording is transmitted responsive to receipt, at the first device, of a request for the recording from one of the second and third devices.

17. The method of claim 12, comprising:
controlling a display to present a graphical user interface (GUI), the GUI indicating that the recording is associated with a particular participant of the electronic conference, the GUI comprising a selector that is selectable to request the recording.

18. The method of claim 17, wherein the display is located on one of the second and third devices, and wherein the first device controls the display through a software application being used to facilitate the electronic conference.

19. At least one computer readable storage medium (CRSM) that is not a transitory signal, the computer readable storage medium comprising instructions executable by at least one processor to:
facilitate, at a first device, a video conference with a second device;
receive a transmission from a third device to begin recording the video conference locally at the first device, the third device being different from the first and second devices;
based on the transmission, begin recording the video conference locally at the first device, the video conference being recorded locally at the first device from a point other than the beginning of the video conference;
save the local recording at the first device; and
transmit the local recording to the third device.

20. The CRSM of claim 19, wherein the local recording is a first recording, and wherein the instructions are executable to:
present a graphical user interface (GUI) on a display accessible to the first device, the GUI indicating that a second recording associated with a user of the second device is available, the second recording being different from the first recording, the GUI comprising a selector that is selectable to request the second recording be transmitted to the first device.
